(19) United States
(12) Patent Application Publication
(10) Pub. No.: US 2012/0168080 A1
(43) Pub. Date: Jul. 5, 2012

(54) COMPOSITIONS ON THE BASIS OF SILANE-TERMINATED POLYMERS

(75) Inventors: Fabien CHOFFAT, Ruttenen (CH); Sara Fedier, Dietlikon (CH)

(73) Assignee: Sika Technology AG, Baar (CH)

(21) Appl. No.: 13/404,821

(22) Filed: Feb. 24, 2012

Related U.S. Application Data
(63) Continuation of application No. PCT/EP2010/062326, filed on Aug. 24, 2010.

(30) Foreign Application Priority Data
Aug. 24, 2009 (EP) 09168475.3

(51) Int. Cl. B32B 37/12; C09D 175/04; C09J 175/04; C08G 18/77

(52) U.S. Cl. 156/329; 528/10; 524/588

(57) ABSTRACT

A composition, including a) at least one silane-functional polymer P; and b) at least one alkyltrialkoxysilane of the formula (I): R²—Si—(OR¹)₃, where R¹ is a linear or branched univalent hydrocarbon group having from 1 to 12 carbon atoms, which optionally includes one or more C—C multiple bonds and/or optionally cycloaliphatic and/or aromatic groups; and R² is a branched hydrocarbon group having from 6 to 10 carbon atoms. In the cured state, compositions have good mechanical properties and good adhesion properties, and exhibit improved extensibility and a low modulus of elasticity.

### RELATED APPLICATION(S)

This application claims priority as a continuation application under 35 U.S.C. §120 to PCT/EP2010/062326, which was filed as an International Application on Aug. 24, 2010 designating the U.S., and which claims priority to European Application 09168475.3 filed in Europe on Aug. 24, 2009. The entire contents of these applications are hereby incorporated by reference in their entireties.

### FIELD

Disclosed are moisture-curing compositions based on silane-functional polymers that are suitable as, for example, adhesives, sealants or coatings.

### BACKGROUND INFORMATION

Moisture-curing compositions based on silane-functional polymers can be used as elastic adhesives, sealants and coatings.

Numerous applications, e.g., in the bonding, sealing or coating of materials having different coefficients of thermal expansion or of substrates subject to vibrations, employ compositions which display good mechanical properties and good adhesion properties in the cured state. Exemplary properties are high extensibility, good retroactivity, a low modulus and high tear-propagation resistance. Compositions often fail to exhibit adequate properties.

Different approaches for producing low modulus, that is, elastic compositions have been adopted.

For example, EP 1 877 459 A1 describes compositions with increased extensibility comprising a silane-functional polymer, an aminosilane and specific a-functional organodialkoxysilanes that result in lower degrees of crosslinking and thus lower the module of the cured composition. Said compositions are detrimental in that highly reactive and comparatively expensive α-functional organodialkoxysilanes are used.

Furthermore, e.g. WO 03/066701 A1 describes compositions based on silane-functional polymers comprising polyurethane polymers having alkoxysilane and hydroxyl terminal groups based on high-molecular polyurethane polymers with reduced functionality. Here, the relatively complex manufacture of said polyurethane polymers having alkoxysilane and hydroxyl terminal groups can be disadvantageous.

The plasticizer concentration of the composition can be increased in order to lower the module. This may however result in plasticizer migration and/or phase separation.

### SUMMARY

According to an exemplary aspect, a composition is provided, comprising: a) at least one silane-functional polymer P; and b) at least one alkyltrialkoxysilane of the formula (I),

R²—Si—(OR¹)₃ (I)

wherein R¹ represents a linear or branched univalent hydrocarbon moiety comprising from 1 to 12 carbon atoms, which optionally comprises one or more C—C multiple bonds and/or optionally one or more cycloaliphatic and/or aromatic groups; and R² represents a branched hydrocarbon moiety comprising from 6 to 10 carbon atoms.

According to another exemplary aspect, a process for bonding two substrates S1 and S2 is provided, the process comprising: i) applying the composition according to claim 1 to a substrate S1 and/or a substrate S2; ii) contacting the substrates S1 and S2 via the applied composition within an open time of the composition; and iii) curing the composition with water, wherein the substrates S1 and S2 are of the same or different material.

According to another exemplary aspect, a process for sealing or coating is provided, comprising: i) applying the composition according to claim 1 to a substrate S1 and/or between two substrates S1 and S2; and ii) curing the composition with water, wherein the substrates S1 and S2 are of the same or different material.

### DETAILED DESCRIPTION

Provided is an exemplary moisture-curing composition based on silane-functional polymers that, in the cured state, has good mechanical properties and good adhesion properties and at the same time exhibits improved extensibility and a low modulus of elasticity.

The modulus of moisture-curing compositions based on silane-functional polymers can be lowered in a simple manner by using specific alkyltrialkoxysilanes. In the cured state, the composition has good mechanical properties and good adhesion properties and at the same time exhibits improved extensibility and a low modulus of elasticity.

Disclosed is a composition, comprising
a) at least one silane-functional polymer P; and
b) at least one alkyltrialkoxysilane of the formula (I),

R²—Si—(OR¹)₃ (I)

where
R¹ represents a linear or branched univalent hydrocarbon moiety having from 1 to 12 carbon atoms, which comprises optionally one or more C—C multiple bonds and/or optionally cycloaliphatic and/or aromatic fractions; and
R² represents a branched hydrocarbon moiety having from 6 to 10 carbon atoms.

Substance names starting with “poly” such as polyol or polyisocyanate as used in the present document refer to substances formally containing two or more functional groups appearing in their name per molecule.

The term “polymer” as used in the present document, on the one hand, includes a collective of chemically uniform macromolecules differing with respect to their degree of polymerization, molecular weight and chain length, said collective being produced by a polyreaction (polymerization, polyaddition, poly-condensation). The term also comprises derivatives of said collective of macromolecules resulting from polyreactions, that is, compounds which were obtained by reactions such as, e.g., additions or substitutions of functional groups in predetermined macromolecules. Those may be chemically uniform or chemically non-uniform. Moreover, the term also comprises so-called prepolymers, that is, reactive organic pre-adducts, the functional groups of which participate in the formation of macromolecules.

The term “polyurethane polymer” comprises all polymers manufactured according to the so-called diisocyanate polyaddition process. This term also includes those polymers that are nearly or completely free from urethane groups. Examples of polyurethane polymers are polyether polyurethanes, polyester polyurethanes, polyether polyureas, polyureas, polyester polyureas, polyisocyanurates and polycarbodiimides.

In the present document, the terms “silane” and “organosilane” refer to compounds that on the one hand, have at least one, for example, two or three alkoxy groups or acyloxy groups directly bonded to the silicon atom, and, on the other hand, at least one organic moiety directly bonded to the silicon atom via an SiC bond. Such silanes are referred to as organoalkoxysilanes or organoacyloxy-silanes.

The term “silane group” refers to the silicon-containing group bonded to the organic moiety of the silane via the SiC bond. Silanes, that is, their silane groups, have the property of being hydrolyzed on contact with moisture. This hydrolysis is accompanied by the formation of organosilanols, i.e., organosilicon compounds containing one or more silanol groups (Si—OH groups) and, as a result of subsequent condensation reactions, of organosiloxanes, i.e., organosilicon compounds containing one or more siloxane groups (Si—O—Si groups).

The term “silane-functional” refers to compounds, which have silane groups. Hence, “silane-functional polymers” are polymers which have at least one silane group.

“Aminosilanes” or “mercaptosilanes” refer to organosilanes, the organic moiety of which has an amino group or a mercapto group, respectively. Aminosilanes that have a primary amino group, i.e., an NH₂ group, which is bonded to an organic moiety, are referred to as “primary aminosilanes.” Aminosilanes that have a secondary amino group, i.e., an NH group, which is bonded to two organic moieties, are referred to as “secondary aminosilanes.”

In this document, “molecular weight” is always defined as the number average molecular weight Mₙ (number average).

The term “room temperature” as used in the present document refers to a temperature of 23° C.

An exemplary composition contains at least one silane-functional polymer P having, for example, terminal groups of the formula (II).

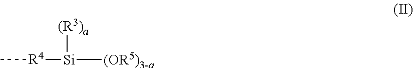

In this polymer the moiety R³ represents a linear or branched univalent hydrocarbon moiety having from 1 to 8C atoms, for example, a methyl or ethyl group.

The moiety R⁴ represents a linear or branched divalent hydrocarbon moiety having from 1 to 12C atoms that optionally has cyclic and/or aromatic fractions and optionally one or more heteroatoms, for example, one or more nitrogen atoms.

The moiety R⁵ represents an acyl moiety or a linear or branched univalent hydrocarbon moiety having from 1 to 5C atoms, for example, a methyl or ethyl or isopropyl group.

The index ‘a’ stands for a value of 0 or 1 or 2, for example, for a value of 0.

Within a silane group of Formula (II), R³ and R⁵, in each case independently of one another, represent the described moieties. Thus, for example, compounds with terminal groups of formula (II), which are ethoxy-dimethoxysilane terminal groups (R⁵=methyl, R⁵=methyl, R⁵=ethyl), are also possible.

In a first embodiment, the silane-functional polymer P is a silane-functional polyurethane polymer P1, which can be obtained by the reaction of a silane, which has at least one group that is reactive to isocyanate groups, with a polyurethane polymer, which has isocyanate groups. This reaction can be performed in a stoichiometric ratio of 1:1 of the groups which are reactive to isocyanate groups to the isocyanate groups or with a slight excess of groups that are reactive to isocyanate groups, such that the resulting silane-functional polyurethane polymer P1 is completely free of isocyanate groups.

In the reaction of the silane, which has at least one group that is reactive to isocyanate groups, with a polyurethane polymer, which has isocyanate groups, the silane can be used, for example, under sub-stoichiometric conditions, such that a silane-functional polymer is obtained that has both a member of the silane and isocyanate groups.

The silane, which has at least one group that is reactive to isocyanate groups, is, for example, a mercaptosilane or an aminosilane, for example, an aminosilane.

For example, the aminosilane is an aminosilane AS of the formula (III),

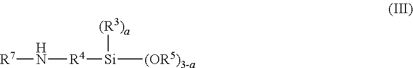

where R³, R⁴, R⁵ and a have been described above and R⁷ represents a hydrogen atom or a linear or branched univalent hydrocarbon moiety having from 1 to 20C atoms, which optionally has cyclic fractions or a moiety of the formula (IV).

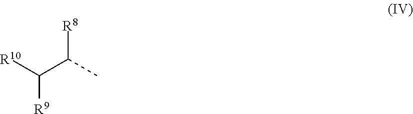

In this formula, the moieties R⁸ and R⁹, represent a hydrogen atom or a moiety selected from the group consisting in each case, and independently of one another, of —R¹¹, —COOR¹¹ and —CN.

The moiety R¹⁰ represents a hydrogen atom or a moiety selected from the group consisting of —CH₂—COOR¹¹, —COOR¹¹, —CONHR¹¹, —CON(R¹¹)₂, —CN, —NO₂, —PO(OR¹¹)₂, —SO₂R¹¹ and —SO₂OR¹¹.

The moiety R¹¹ represents a hydrocarbon moiety having from 1 to 20 C atoms optionally having at least one heteroatom.

Examples of suitable aminosilanes AS are primary aminosilanes such as 3-aminopropyltrimethoxysilane, 3-aminopropyldimethoxymethylsilane; secondary aminosilanes such as N-butyl-3-aminopropyltrimethoxysilane, N-phenyl-3-aminopropyltrimethoxysilane; the products of the Michael-type addition of primary aminosilanes such as 3-aminopropyltrimethoxysilane or 3-aminopropyldimethoxymethylsilane with Michael acceptors such as acrylonitrile, (meth)acrylic esters, (meth)acrylamides, maleic and fumaric diesters, citraconic diesters and itaconic diesters, for example dimethyl and diethyl N-(3-trimethoxysilylpropyl)aminosuccinate; and also analogues of the mentioned aminosilanes having ethoxy or isopropoxy groups instead of the methoxy groups on the silicon. Suitable aminosilanes AS are secondary aminosilanes, for example, aminosilanes AS where R⁷ in formula (III) is other than H. Examples include the Michael-type adducts, for example, diethyl N-(3-trimethoxysilylpropyl)aminosuccinate.

In the present document, the term “Michael acceptor” refers to compounds, which on the basis of the double bonds activated by the contained electron acceptor moieties, are capable of entering together with primary amino groups (NH₂ groups) into a nucleophilic addition reaction, in a manner analogous to that of Michael addition (hetero-Michael addition).

Examples of a suitable polyurethane polymer containing isocyanate groups for the preparation of a silane-functional polyurethane polymer P1 include polymers which are obtainable by the reaction of at least one polyol with at least one polyisocyanate, in particular a diisocyanate. This reaction can be accomplished by reacting the polyol and the polyisocyanate using commonly used methods, for example at temperatures of 50° C. to 100° C., optionally with simultaneous use of suitable catalysts, the amount of polyisocyanate being selected such that its isocyanate groups are present in stoichiometric excess relative to the hydroxyl groups of the polyol.

For example, the excess of polyisocyanate is selected such that, following the reaction of all of the hydroxyl groups of the polyol, the resulting polyurethane polymer retains a free isocyanate group content of from 0.1% to 5% by weight, preferably from 0.1% to 2.5% by weight, for example, of from 0.2% to 1% by weight, based on the overall polymer.

Optionally, the polyurethane polymer can be produced with simultaneous use of softeners, provided that the used softeners do not contain any groups that are reactive to isocyanates.

Preferred polyurethane polymers are those having the stated free isocyanate group content and obtained from the reaction of diisocyanates with high-molecular diols in an NCO:OH ratio of from 1.5:1 to 2.2:1.

Suitable polyols for preparing the polyurethane polymer are, in particular, polyether polyols, polyester polyols and polycarbonate polyols, and also mixtures of these polyols.

Suitable polyoxyalkylene polyols, also called polyether polyols or oligoetherols, are especially those which are polymerization products of ethylene oxide, 1,2-propylene oxide, 1,2- or 2,3-butylene oxide, oxetane, tetrahydrofuran or mixtures thereof, optionally polymerized using a starter molecule with two or more active hydrogen atoms such as, for example, water, ammonia or compounds with several OH or NH groups, such as, for example, 1,2-ethanediol, 1,2- and 1,3-propanediol, neopentylglycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, as well as mixtures of the mentioned compounds. Both polyoxyalkylene polyols with a low degree of unsaturation (measured according to ASTM D-2849-69 and indicated in milliequivalents of unsaturation per gram of polyol (meq/g)) and being produced, for example, using so-called double-metal cyanide complex catalysts (DMC catalysts) as well as polyoxyalkylene polyols having a higher degree of unsaturation and being produced, for example, using anionic catalysts, such as NaOH, KOH, CsOH or alkali alcoholates, can be used.

Suitable are polyoxyethylene polyols and polyoxypropylene polyols, for example, polyoxyethylene diols, polyoxypropylene diols, polyoxyethylene triols and polyoxypropylene triols.

Suitable are polyoxyalkylene diols and polyoxyalkylene triols with a degree of unsaturation that is less than 0.02 meq/g and with a molecular weight in the range of 1,000-30,000 g/mol, as well as polyoxyethylene diols, polyoxyethylene triols, polyoxypropylene diols, polyoxypropylene triols with a molecular weight of from 400 to 20,000 g/mol.

Suitable are so-called ethylene oxide-terminated (“EO-endcapped,” ethylene oxide-endcapped) polyoxypropylene polyols. The latter are special polyoxypropylene polyoxyethylene polyols which can be obtained, for example, in that pure polyoxypropylene polyols, in particular polyoxypropylene diols and -triols, after the polypropoxylation reaction with ethylene oxide is completed, are further alkoxylated and as a result have primary hydroxyl groups. Examples include polyoxypropylene-polyoxyethylene diols and polyoxypropylene-polyoxyethylene triols.

Moreover, polybutadiene polyols terminated with hydroxyl groups, such as those polyols, for example, which are prepared by polymerizing 1,3-butadiene and allyl alcohol or by oxidizing polybutadiene, and also their hydration products, are suitable.

Moreover, polyether polyols grafted with styrene-acrylonitrile of the commercially available kind, for example, under the trade name Lupranol® from the company Elastogran GmbH, Germany, are suitable.

Suitable polyester polyols are polyesters which carry at least two hydroxyl groups and are prepared by any suitable method, for example, by the polycondensation of hydroxycarboxylic acids or the polycondensation of aliphatic and/or aromatic polycarboxylic acids with di- or polyhydric alcohols.

Suitable are polyester polyols which are prepared from di- to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or their anhydrides or esters such as, for example, succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid and trimellitic anhydride or mixtures of the aforementioned acids, and also polyester polyols from lactones such as, e.g., ε-caprolactone.

Suitable are polyester diols, for example, those prepared from adipic acid, azelaic acid, sebacic acid, dodecanedicarboxylic acid, dimer fatty acid, phthalic acid, isophthalic acid and terephthalic acid as dicarboxylic acid or from lactones such as, for example, ε-caprolactone and from ethylene glycol, diethylene glycol, neopentyl glycol, 1,4-butanediol, 1,6-hexanediol, dimer fatty acid diol and 1,4-cyclohexanedimethanol as dihydric alcohol.

Suitable as polycarbonate polyols are those obtainable by reacting, for example, the above-mentioned alcohols used to synthesize the polyester polyols with dialkyl carbonates such as dimethyl carbonate, diaryl carbonates such as diphenyl carbonate or phosgene. Polycarbonate diols, for example, amorphous polycarbonate diols, are suitable.

Further suitable polyols are poly(meth)acrylate polyols.

Polyhydroxy-functional fats and oils, for example, natural fats and oils, for example, castor oil; or polyols—so-called oleochemical polyols—obtained by chemical modification of natural fats and oils, for example, the epoxy polyesters or epoxy polyethers obtained by epoxidation of unsaturated oils and subsequent ring opening with carboxylic acids or alcohols, or polyols obtained by hydroformylation and hydrogenation of unsaturated oils, can be used. Polyols obtained from natural fats and oils by degradation processes such as alcoholysis or ozonolysis and subsequent chemical cross-linking, for example, by re-esterification or dimerization of the thus obtained degradation products or derivatives thereof, are suitable. Suitable degradation products of natural fats and oils are, for example, fatty acids and fatty alcohols as well as fatty acid esters, for example, the methyl esters (FAME) that can be derivatized, for example, by hydroformylation and hydrogenation to form hydroxy fatty acid esters.

Suitable are polyhydrocarbon polyols, also called oligohydrocarbonols, such as, for example, polyhydroxy-functional ethylene-propylene-, ethylene-butylene- or ethylene-propylene-diene copolymers, as they are manufactured by, for example, the company Kraton Polymers, USA, or polyhydroxy-functional copolymers of dienes such as 1,3-butadiene or diene mixtures and vinyl monomers such as styrene, acrylonitrile or isobutylene, or polyhydroxy-functional polybutadiene polyols, for example, those prepared by copolymerizing 1,3-butadiene and allyl alcohol and which may also have been hydrated.

Additionally suitable are polyhydroxy-functional acrylonitrile/butadiene copolymers which can be prepared, for example, from epoxides or amino alcohols and carboxyl-terminated acrylonitrile/butadiene copolymers, which are commercially available under the name Hypro® (previously Hycar®) CTBN from the company Emerald Performance Materials, LLC, USA.

For example, these mentioned polyols have a mean molecular weight of from 250 to 30,000 g/mol, for example, from 1,000-30,000 g/mol, and a mean OH-functionality in the range of from 1.6 to 3.

Suitable polyols are polyester polyols and polyether polyols, for example, polyoxyethylene polyol, polyoxypropylene polyol and polyoxypropylene-polyoxyethylene polyol, for example, polyoxyethylene diol, polyoxy-propylene diol, polyoxyethylene triol, polyoxypropylene triol, polyoxypropylene-polyoxyethylene diol and polyoxypropylene-polyoxyethylene triol.

In addition to these mentioned polyols, small amounts of low-molecular dihydric or polyhydric alcohols, such as, for example, 1,2-ethanediol, 1,2- and 1,3-propanediol, neopentyl glycol, diethylene glycol, triethylene glycol, isomeric dipropylene glycols and tripropylene glycols, isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as saccharose, other polyhydric alcohols, low-molecular alkoxylating products of the above-mentioned di- and polyhydric alcohols as well as mixtures of the above-mentioned alcohols can be used, for example, simultaneously when preparing the polyurethane polymer containing terminal isocyanate groups.

As polyisocyanates for preparing the polyurethane polymer commercially available polyisocyanates, for example, diisocyanates, may be used.

For example, suitable diisocyanates are 1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,12-dodecamethylene diisocyanate, lysine and lysine ester diisocyanate, cyclohexane 1,3-diisocyanate, cyclohexane 1,4-diisocyanate, 1-isocyanato-3,3,5-trimethyl-5-isocyanatomethylcyclohexane (i.e. isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis-(isocyanatomethyl)cyclohexane, m- and p-xylylene diisocyanate (m- and p-XDI), m- and p-tetramethyl-1,3-xylylene diisocyanate, m- and p-tetramethyl-1,4-xylylene diisocyanate, bis-(1-isocyanato-1-methylethyl)naphthalene, 2,4- and 2,6-tolylene diisocyanate (TDI), 4,4′-, 2,4′- and 2,2′-diphenylmethane diisocyanate (MDI), 1,3- and 1,4-phenylene diisocyanate, 2,3,5,6-tetramethyl-1,4-diisocyanatobenzene, naphthalene-1,5-diisocyanate (NDI), 3,3′-dimethyl-4,4′-diisocyanatobiphenyl (TODD, oligomers and polymers of the aforementioned isocyanates, and also any mixtures of the aforementioned isocyanates.

Suitable silane-functional polymers P1 are, for example, commercially available under the trade name Polymer ST, for example, Polymer ST50 from the company Hanse Chemie AG, Germany, and also under the trade name Desmoseal® from the company Bayer MaterialScience AG, Germany.

In a second embodiment the silane-functional polymer P contains a silane-functional polyurethane polymer P2 obtainable by the reaction of an isocyanatosilane IS with a polymer, which has functional terminal groups reactive towards isocyanate groups, especially hydroxyl groups, mercapto groups and/or amino groups. This reaction takes place in a stoichiometric ratio of the isocyanate groups to the functional terminal groups that are reactive towards isocyanate groups of 1:1, or with a slight excess of the functional terminal groups that are reactive towards isocyanate groups, at temperatures, for example, of from 20° C. to 100° C., where appropriate with accompanying use of catalysts.

Suitable isocyanatosilanes IS are compounds of the formula (V).

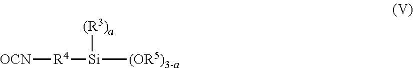

where R³, R⁵, R⁴ and a have been described above.

Examples of suitable isocyanatosilanes IS of the formula (V) are isocyanatomethyltrimethoxysilane, isocyanatomethyldimethoxymethylsilane, 3-isocyanatopropyltrimethoxysilane, 3-isocyanatopropyldimethoxymethylsilane and their analogues having ethoxy or isopropoxy groups instead of the methoxy groups on the silicon.

The polymer can contain hydroxyl groups as functional terminal groups reactive towards isocyanate groups.

Suitable polymers containing hydroxyl groups are, on the one hand, aforementioned polyoxyalkylene polyols of high molecular weight, for example, polyoxypropylene diols having a degree of unsaturation of less than 0.02 meq/g and having a molecular weight in the range of from 4,000 to 30,000 g/mol, for example, those having a molecular weight in the range of from 8,000 to 30,000 g/mol.

Also suitable, on the other hand, are polyurethane polymers containing hydroxyl groups, for example, polyurethane polymers terminated by hydroxyl groups, for the reaction with isocyanatosilanes IS of the formula (V). Such polyurethane polymers are obtainable by reacting at least one polyisocyanate with at least one polyol. This reaction can be accomplished by reacting the polyol and the polyisocyanate using any suitable method, for example at temperatures of 50° C. to 100° C., optionally with simultaneous use of suitable catalysts, the amount of polyol being selected such that its hydroxyl groups are present in stoichiometric excess relative to the isocyanato groups of the polyisocyanate. For example, a ratio of hydroxyl groups to isocyanate groups is from 1.3:1 to 4:1, in particular from 1.8:1 to 3:1.

Optionally, the polyurethane polymer can be produced with simultaneous use of softeners, provided that the used softeners do not contain any groups that are reactive to isocyanates.

Suitable for this reaction are the same polyols and polyisocyanates that have already been mentioned as being suitable for preparing a polyurethane polymer-containing isocyanate groups used for preparing a silane-functional polyurethane polymer P1.

For example, suitable silane-functional polymers P2 are commercially available under the trade names SPUR+® 1010LM, 1015LM and 1050MM from the company Momentive Performance Materials Inc., USA, and also under the trade names Geniosil® STP-E15, STP-10 and STP-E35 from the company Wacker Chemie AG, Germany.

In a third embodiment, the silane-functional polymer P is a silane-functional polymer P3 which is obtainable by a hydrosilylation reaction of polymers having terminal double bonds, examples being poly(meth)acrylate polymers or polyether polymers, for example, of allyl-terminated polyoxyalkylene polymers, as described, for example, in U.S. Pat. No. 3,971,751 and U.S. Pat. No. 6,207,766, the complete contents of which are incorporated herein by reference.

For example, suitable silane-functional polymers P3 are commercially available under the trade names MS Polymer™ S203H, S303H, S227, S810, MA903 and S943, Silyl™ SAX220, SAX350, SAX400 and SAX725, Silyl™ SAT350 and SAT400, and XMAP™ SA100S and SA310S from the company Kaneka Corp., Japan, and under the trade names Excestar® S2410, S2420, S3430, S3630, W2450 and MSX931 from the company Asahi Glass Co., Ltd., Japan.

The silane-functional polymer P can be present in quantities from 10% to 80% by weight, for example, in quantities from 15% to 70% by weight, for example, of from 20% to 40% by weight, based on the overall composition.

For example, in an exemplary composition, the moiety R⁵ in the terminal groups of the formula (ii) corresponds to the moiety R¹ in the alkyltrialkoxysilane of the formula (I).

For example, the silane-functional polymer P of an exemplary composition contains terminal groups of the formula (II′)

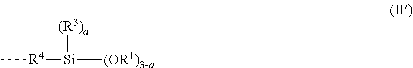

where R¹ both in the silane-functional polymer P and in the alkyltrialkoxysilane of the formula (I) can be selected from the moieties which have been described above.

The moieties R³ and R⁴ and the index a have also been described above.

The composition according to the disclosure comprises at least one alkyltrialkosysilane of the formula (I), which has been described above.

For example, the moiety R¹ represents a methyl or an ethyl or an isopropyl group, for example, a methyl group.

For example, the moiety R² represents a branched hydrocarbon moiety having 8C atoms. For example, the branched hydrocarbon moiety is a multi-branched alkyl group. Another exemplary branched hydrocarbon moiety contains a tertiary butyl group. For example, the moiety R² represents a 2,4,4-trimethylpentyl moiety.

For example, the alkyltrialkosysilane of the formula (I) in an exemplary composition is trimethoxy(2,4,4-trimethylpentyl)silane.

For example, the content of the alkyltrialkoxysilane of the formula (I) is from 0.05% to 4% by weight of the overall composition.

The composition can further contain at least one filler. The filler influences both the rheological properties of the uncured composition and the mechanical properties and the surface characteristics of the cured composition. Suitable fillers are inorganic and organic fillers, for example, natural, ground or precipitated calcium carbonates optionally coated with fatty acids, for example, stearic acid, barium sulfate (BaSO₄, also called barite or heavy spar), calcined kaolins, aluminas, aluminum hydroxides, silicas, for example, highly dispersed silicas from pyrolysis processes, carbon blacks, for example, industrially produced carbon black, PVC powders or hollow spheres. Exemplary fillers are calcium carbonates, calcined kaolins, carbon black, finely divided silicas and flame-retardant fillers such as hydroxides or hydrates, for example, hydroxides or hydrates of aluminum, for example, aluminum hydroxide.

It is entirely possible and may even be advantageous to use a mixture of different fillers.

A suitable amount of filler is, for example, within the range from 20% to 60% by weight, for example, 30% to 60% by weight, based on the overall composition.

The composition according to the disclosure further comprises, for example, at least one catalyst for the crosslinking of the silane-functional polymers by means of moisture. Such catalysts can be metal catalysts in the form of organotin compounds such as dibutyltin dilaurate and dibutyltin diacetylacetonate, titanium catalysts, compounds containing amino groups, for example, 1,4-diazabicyclo-[2.2.2]octane and 2,2′-dimorpholinodiethyl ether, aminosilanes and mixtures of the mentioned catalysts.

The composition may additionally comprise further components. For example, such components can include plasticizers such as esters of organic carboxylic acids or anhydrides thereof, such as phthalates, for example, dioctyl phthalate, diisononyl phthalate or diisodecyl phthalate, adipates, for example, dioctyl adipate, azelates and sebacates, polyols, for example polyoxyalkylene polyols or polyester polyols, organic phosphoric and sulfonic esters or polybutenes; solvents; fibers, for example of polyethylene; dyes; pigments; rheology modifiers such as thickeners or thixotropic agents, for example urea compounds of the type described as “thixotropy endowing agents” in WO 02/48228 A2 on pages 9 to 11, polyamide waxes, bentonites or pyrogenic silicic acids; adhesion promoters, for example epoxysilanes, (meth)acryloylsilanes, anhydridosilanes or adducts of the aforementioned silanes with primary aminosilanes, and aminosilanes or ureasilanes; crosslinkers, for example, silane-functional oligo- and polymers; desiccants, for example vinyltrimethoxysilane, α-functional silanes such as N-(silylmethyl) O-methyl-carbamates, in particular N-(methyldimethoxysilylmethyl) O-methylcarbamate, (methacryloyloxymethyl)silanes, methoxymethylsilanes, N-phenyl-, N-cyclohexyl- and N-alkylsilanes, orthoformic esters, calcium oxide or molecular sieves; stabilizers, for example against heat, light and UV radiation; flame-retardant substances; surface-active substances such as wetting agents, leveling agents, deaerating agents or defoamers; biocides such as algicides, fungicides or fungal growth-inhibiting substances; and further substances usually used in moisture-curing compositions.

So-called reactive diluents, which are incorporated into the polymer matrix during curing of the composition, for example, by reaction with the silane groups, can optionally be used.

It can be beneficial to select all components mentioned, which may optionally be present in the composition, for example, filler and catalyst, such that the storage stability of the composition is not adversely affected by the presence of such a component, which means that the properties of the composition, for example, the application and curing properties, are altered only slightly, if at all, during storage. This requires that reactions leading to chemical curing of the described composition, for example, of the silane groups, do not occur to a significant degree during storage. It is therefore can be beneficial that the mentioned components contain, or release during storage, at most traces of water, if any. It may therefore be advisable to dry certain components chemically or physically before mixing them into the composition.

After curing, for example, after curing for at least 14 days at 23° C. and a relative humidity of 50%, the composition can have a modulus of elasticity at 0 to 100% elongation of ≦0.4 MPa, measured according to DIN EN 53504 with a tensile speed of 200 mm/min, and a Shore A hardness of ≧10, measured according to DIN 53505.

The above-described composition can be produced and stored with exclusion of moisture. The composition is typically storage-stable, which means that it can be stored with exclusion of moisture in a suitable package or arrangement, for example a drum, a pouch or a cartridge, over a period of several months up to one year or longer, without any change to a degree relevant for the use thereof in the performance properties thereof or in the properties thereof after curing. Usually, the storage stability can be determined by measuring viscosity or the extrusion force.

When the described composition is applied to at least one solid or article, the silane groups of the polymer come into contact with moisture. Silane groups have the property of being hydrolyzed on contact with moisture. This results in the formation of organosilanols and, by subsequent condensation reactions, organosiloxanes. As a result of these reactions, which can be accelerated by the use of catalysts, the composition ultimately cures. This process is also referred to as crosslinking.

The water employed for curing can either come from the air (air moisture) or the above-mentioned composition can be contacted with a component-containing water, e.g., by brushing, e.g., using a smoothing agent, or by spraying, or, during application, a water-containing component can be added to the composition, e.g., in the form of an aqueous paste, which is mixed in, for example, with a static mixer. In the case of curing by means of air humidity, the composition cures from the outside inwards. The rate of curing is determined by various factors, for example the diffusion rate of the water, the temperature, the ambient humidity and the adhesive geometry, and generally slows with advancing curing.

Also disclosed is the use of an above-described composition as a moisture-curing adhesive, sealant or coating, for example, as construction sealant. The use as low modulus construction sealant for connection and dilation joints is exemplary.

For example, a composition can be used in a process for bonding two substrates S1 and S2, comprising the steps of
i) applying a composition according to the above description to a substrate S1 and/or a substrate S2;
ii) contacting the substrates S1 and S2 via the applied composition within the open time of the composition;
iii) curing the composition by means of water;
   where the substrates S1 and S2 are the same or different.

A composition can be used in a sealing or coating process comprising the steps of
i′) applying a composition according to the above description to a substrate S1 and/or between two substrates S1 and S2;
ii)′ curing the composition by means of water, for example, in the form of air humidity;
   where the substrates S1 and S2 are the same or different.

Suitable substrates S1 and/or S2 are, for example, substrates selected from the group consisting of concrete, mortar, brick, tile, gypsum, natural stone such as granite or marble, glass, glass ceramic, metal or metal alloy, wood, plastic and paint.

The composition can have a pasty consistency with structurally viscous properties. Such a composition is applied to the substrate by means of a suitable device, for example, in the form of a bead, which can have a substantially round or triangular cross-sectional area. Suitable methods for applying the composition are, for example, application from commercially available cartridges, which can be operated manually or by compressed air, or from a barrel or hobbock by means of a feed pump or an extruder, optionally by means of an application robot. A composition is disclosed with good application properties has a high stability under load and low stringiness. This means that it remains in the applied form after application. This means it does not flow and does not draw a thread, or only a very short thread, if any, thus reducing or avoiding soiling of the substrate.

The disclosure further relates to a cured composition obtainable by the reaction of an above-described composition after the curing thereof with water, for example, in the form of air humidity.

The bonded, sealed or coated articles with an exemplary composition are, for example, a building or a built structure in construction or civil engineering, an industrially manufactured good or a consumer good, for example, a window, a domestic appliance, or a means of transport or an installed component of a means of transport.

Disclosed is the use of an alkyltrialkoxysilane of the formula (I) described above as a component in compositions based on silane-terminated polymers for increasing the elasticity and decreasing the modulus of elasticity of said compositions in the cured state.

### EXAMPLES

Hereinafter, exemplary embodiments intended to illustrate the disclosure described herein in more detail are presented. It will be appreciated that the disclosure is not restricted to these described embodiments.

### Test Methods

Tensile strength, elongation at break and modulus of elasticity at 0 to 100% elongation were determined according to DIN EN 53504 (tensile speed: 200 mm/min) using films with a layer thickness of 2 mm cured at 23° C. and a relative humidity of 50% during 14 days.

The tensile modulus was determined according to DIN EN ISO 8340 using concrete test samples (concrete, wet, according to ISO 13640, from the company Rocholl GmbH, Germany, 70 mm×25 mm×12.5 mm) pretreated with Sika® Primer-3 N (commercially available from Sika® Schweiz AG). The test samples were cured for 4 weeks at 23° C. and a relative humidity of 50%.

The Shore A hardness was determined according to DIN 53505 using test samples with a layer thickness of 6 mm cured for 14 days at 23° C. and a relative humidity of 50%.

The skin formation time (time until freedom from adhesion, “tack-free time”) was determined at 23° C. and a relative humidity of 50%. To measure the skin formation time, a small portion of the room-temperature adhesive was applied on cardboard in a layer thickness of approximately 2 mm, and the time that it took until no more residues were left on the pipette when the surface of the adhesive was touched slightly by means of a pipette made of LDPE was determined.

The tear-propagation resistance was determined according to DIN 53515 using films with a layer thickness of 2 mm cured for 14 days at 23° C. and a relative humidity of 50%.

### Preparation of the Silane-Functional Polyurethane Polymer SH

Under a nitrogen atmosphere, 700 g of the polyol Acclaim® 12200 (Bayer MaterialScience AG, Germany; low monol polyoxy-propylene diol; OH number 11.0 mg KOH/g; water content approx. 0.02% by weight), 24.6 g of isophorone diisocyanate (Vestanat® IPDI, Evonik Degussa GmbH, Germany), 182 g of 2,2,4-trimethyl-1,3-pentanedioldiisobutyrate (Eastman TXIB™; Eastman Chemical Company, USA) and 0.1 g of di-n-butyl tin dilaurate (Metatin® K 712, Acima AG, Switzerland) were heated to 90° C. with continuous stirring and kept at this temperature. After a reaction time of one hour, the titrimetrically determined content of free isocyanate groups had reached a value of 0.32% by weight. Subsequently, 24.5 g of N-(3-trimethoxysilylpropyl)-aminosuccinic acid diethyl ester was added, and the mixture was stirred at 90° C. for additional 2 to 3 hours. The reaction was stopped when free isocyanate could no longer be detected by means of IR spectroscopy (2275-2230 cm⁻¹). The product was cooled to room temperature (23° C.) and stored under the exclusion of moisture (theoretical polymer content=80%). The thus-obtained silane-functional polyurethane polymer SH is liquid at room temperature.

N-(3-trimethoxysilylpropyl)-aminosuccinic acid diethyl ester was prepared as follows: 49.0 g of maleic acid diethyl ester (Fluka Chemie GmbH, Switzerland) was slowly added to 51.0 g of 3-aminopropyltrimethoxysilane (Silquest® A-1110, Momentive Performance Materials Inc., USA) with vigorous stirring at room temperature and the mixture was stirred for 2 hours at room temperature.

### Preparation of the Thixotropic Agent TM

1000 g of diisodecyl phthalate (Palatinol® Z, BASF SE, Germany) and 160 g of 4,4′-diphenylmethane diisocyanate (Desmodur® 44 MC L, Bayer MaterialScience AG, Germany) were added to a vacuum mixer and slightly heated. Subsequently, 90 g of monobutylamine was slowly added dropwise under vigorous stirring. The resulting white paste was further stirred under vacuum and cooled for one hour. The thixotropic agent TM contains 20% by weight of the thixotropic agent in 80% by weight diisodecyl phthalate.

### Preparation of Adhesives

In a vacuum mixer, a silane-functional polymer (SH or MS), the thixotropic agent TM and vinyltrimethoxysilane (Silquest® A-171 from Momentive Performance Materials Inc., USA) as indicated in parts by weight in tables 1 and 2 were thoroughly mixed for 5 minutes. Subsequently, dried, precipitated chalk (Socal® U1S2, Solvay SA, Belgium, and Omyacarb® 5-GU, Omya AG, Switzerland) was added with kneading during 15 minutes at 60° C. With the heater switched off, N-(2-aminoethyl)-(3-aminopropyl)trimethoxysilane (Silquest® A-1120 from Momentive Performance Materials Inc.) and catalyst (Metatin® K712 as 10% solution in DIDP) were subsequently processed to a homogeneous paste during 10 minutes under vacuum. Said paste was subsequently filled into internally coated aluminum spreading piston cartridges.

TABLE 1
Compositions of the exemplary adhesives 1 to 4 and reference
examples 5 to 9, in parts by weight, and results

| | 1 | 2 | 3 | 4 | 5 | 6 | 7 | 8 | 9 |
|---|---|---|---|---|---|---|---|---|---|
| SH | 120 | 120 | 120 | 120 | 120 | 120 | 120 | 120 | 120 |
| Silquest ® A-171 | 4 | 4 | 4 | 4 | 4 | 4 | 4 | 4 | 4 |
| TM | 100 | 100 | 100 | 100 | 100 | 100 | 100 | 100 | 100 |
| Omyacarb ® 5-GU | 80 | 80 | 80 | 80 | 80 | 80 | 80 | 80 | 80 |
| Socal ® U1S2 | 80 | 80 | 80 | 80 | 80 | 80 | 80 | 80 | 80 |
| Silquest ® A-1120 | 2 | 2 | 2 | 2 | 2 | 2 | 2 | 2 | 2 |
| Metatin ® K712 ^{a)} | 10 | 10 | 10 | 10 | 10 | 10 | 10 | 10 | 10 |
| Silane R^{2′}—Si(OCH₃)₃ | | | | | | | | | |
| R^{2′}: 2,4,4-trimethyl- | 1 | 2 | 4 | 8 | | | | | |
| pentyl ^{b)} | | | | | | | | | |
| R^{2′}: methyl ^{b)} | | | | | | 4 | | | |
| R^{2′}: n-octyl ^{c)} | | | | | | | 4 | | |
| R^{2′}: n-hexadecyl ^{b)} | | | | | | | | 4 | |
| R^{2′}: i-butyl ^{b)} | | | | | | | | | 4 |
| Tensile strength [MPa] | 1.3 | 1.3 | 1.3 | 1.0 | 1.4 | 1.2 | 1.3 | 1.3 | 1.3 |
| Elongation at break [%] | 681 | 754 | 932 | 936 | 497 | 368 | 695 | 724 | 735 |
| Modulus of elasticity | 0.39 | 0.36 | 0.32 | 0.23 | 0.46 | 0.47 | 0.39 | 0.39 | 0.36 |
| [MPa] | | | | | | | | | |
| Tensile modulus [MPa] | 0.41 | 0.35 | 0.30 | 0.21 | 0.48 | 0.48 | 0.36 | 0.38 | 0.37 |
| Skin formation time | 65 | 80 | 80 | 105 | 45 | 70 | 105 | 80 | 80 |
| [min] | | | | | | | | | |
| Shore A | 21 | 19 | 17 | 13 | 20 | 25 | 20 | 20 | 20 |
| Tear-propagation | 6.1 | 6.3 | 6.4 | 5.7 | 6.1 | 5.0 | 5.8 | 6.1 | 6.0 |
| resistance [N/mm] | | | | | | | | | |

^{a)} 10% solution in DIDP;
^{b)} obtainable from Wacker Chemie AG, Germany;
^{c)} obtainable from ABCR GmbH & Co KG, Germany.

TABLE 2
Compositions of exemplary adhesives 10 and 11 and reference
example 13, in parts by weight, and results

| | 10 | 11 | 12 |
|---|---|---|---|
| MS ^{d)} | 120 | 120 | 120 |
| Silquest ® A-171 | 4 | 4 | 4 |
| TM | 100 | 100 | 100 |
| Omyacarb ® 5-GU | 80 | 80 | 80 |
| Socal ® U1S2 | 80 | 80 | 80 |
| Silquest ® A-1120 | 2 | 2 | 2 |
| Metatin ® K740 | 1.2 | 1.2 | 1.2 |
| Silane R^{2′}—Si(OCH₃)₃ | | | |
| R^{2′}: 2,4,4-trimethylpentyl | 2 | 4 | |
| Tensile strength [MPa] | 1.2 | 1.1 | 1.1 |
| Elongation at break [%] | 617 | 695 | 474 |
| Modulus of elasticity [MPa] | 0.37 | 0.31 | 0.42 |
| Tensile modulus [MPa] | 0.43 | 0.37 | 0.49 |
| Shore A | 24 | 22 | 26 |
| Tear-propagation resistance | 4.2 | 4.3 | 4.2 |
| [N/mm] | | | |

^{d)} MS: MS Polymer S303H, Kaneka Corp., Japan.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A composition, comprising:
a) at least one silane-functional polymer P; and
b) at least one alkyltrialkoxysilane of the formula (I),
R²—Si—(OR¹)₃ (I)
wherein
R¹ represents a linear or branched univalent hydrocarbon moiety comprising from 1 to 12 carbon atoms, which optionally comprises one or more C—C multiple bonds and/or optionally one or more cycloaliphatic and/or aromatic groups; and
R² represents a branched hydrocarbon moiety comprising from 6 to 10 carbon atoms.

2. The composition according to claim 1, wherein R¹ represents a methyl or an ethyl or an isopropyl group.

3. The composition according to claim 2, wherein R¹ represents a methyl group.

4. The composition according to claim 1, wherein R² represents a branched hydrocarbon moiety comprising 8 carbon atoms.

5. The composition according to claim 1, wherein R² represents a polybranched alkyl group.

6. The composition according to claim 1, wherein R² represents a 2,4,4-trimethylpentyl moiety.

7. The composition according to claim 1, wherein the alkyltrialkoxysilane of the formula (I) is trimethoxy(2,4,4-trimethylpentyl)silane.

8. The composition according to claim 1, wherein the silane-functional polymer P has terminal groups of the formula (II′) 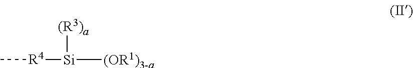
wherein
R¹ represents a linear or branched univalent hydrocarbon moiety comprising from 1 to 12 carbon atoms, which optionally comprises one or more C—C multiple bonds and/or optionally one or more cycloaliphatic and/or aromatic groups;
R³ represents an alkyl group having from 1 to 8 carbon atoms;
R⁴ represents a linear or branched, optionally cyclic alkylene group comprising from 1 to 12C atoms, optionally with one or more aromatic groups, and optionally with one or more heteroatoms; and
a represents a value of 0 or 1.

9. The composition according to claim 1, wherein the content of alkyltrialkoxysilane of the formula (I) is from 0.05 to 4% by weight of the entire composition.

10. The composition according to claim 1, wherein the composition, after curing, has a modulus of elasticity at 0 to 100% elongation of ≦0.4 MPa, measured according to DIN EN 53504 with a tensile speed of 200 mm/min, and a Shore A hardness of ≧10, measured according to DIN 53505.

11. The composition according to claim 1, wherein the composition is a moisture-curing adhesive, sealant or coating.

12. The composition according to claim 11, wherein the composition is a construction sealant.

13. A cured composition obtained from the composition according to claim 1 after the curing thereof with water.

14. The composition according to claim 1, wherein the alkyltrialkoxysilane of the formula (I) is effective to increase the elasticity and decrease the modulus of elasticity of said composition in the cured state.

15. The composition according to claim 1, wherein R¹ represents a methyl or an ethyl or an isopropyl group, and R² represents a branched hydrocarbon moiety comprising 8 carbon atoms.

16. The composition according to claim 1, wherein the silane-functional polymer P is a silane-functional polyurethane polymer.

17. A process for bonding two substrates S1 and S2, the process comprising:
i) applying the composition according to claim 1 to a substrate S1 and/or a substrate S2;
ii) contacting the substrates S1 and S2 via the applied composition within an open time of the composition; and
iii) curing the composition with water,
wherein the substrates S1 and S2 are of the same or different material.

18. The process according to claim 17, wherein each of substrates S1 and S2 is concrete, mortar, brick, tile, gypsum, natural stone, glass, glass ceramic, metal or metal alloy, wood, plastic or paint.

19. A process for sealing or coating, comprising:
i) applying the composition according to claim 1 to a substrate S1 and/or between two substrates S1 and S2; and
ii) curing the composition with water,
wherein the substrates S1 and S2 are of the same or different material.

20. The process according to claim 19, wherein in ii), the composition is cured with water in the form of air humidity.
